(19) United States
(12) Patent Application Publication
(10) Pub. No.: US 2021/0392909 A1
(43) Pub. Date: Dec. 23, 2021

(54) Contact drum freezer system for automated and/or mechanized food process lines, and products produced thereby

(71) Applicant: Robert G. Nothum, JR., Springfield, MO (US)

(72) Inventor: Robert G. Nothum, JR., Springfield, MO (US)

(21) Appl. No.: 17/300,468

(22) Filed: Jul. 9, 2021

Related U.S. Application Data
(63) Continuation-in-part of application No. 16/658,429, filed on Oct. 21, 2019.
(60) Provisional application No. 62/748,714, filed on Oct. 22, 2018.
(60) Provisional application No. 63/049,723, filed on Jul. 9, 2020.

(51) Int. Cl. A23B 4/06; F25D 13/06

(52) U.S. Cl. CPC A23B 4/064; F25D 2400/30; F25D 13/06

(57) ABSTRACT

A contact drum freezer system includes a contact drum freezer, an endless product wrap belt and a cross feed conveyor. The contact drum freezer is mounted to revolve about an axis generally parallel to a main lane of transit. The endless product wrap belt has an intake shelf, an inner product-compressing run encircling most of the drum and an outer return run looping back to the intake shelf. The cross feed conveyor is situated in the main lane of transit and has a return run a and product-carrying run for transferring product laterally out of the main lane of transit and onto the intake shelf of the product wrap belt.

### CROSS-REFERENCE TO RELATED APPLICATION(S)

This application is a continuation-in-part of U.S. patent application Ser. No. 16/658,429, filed Oct. 21, 2019; which claims the benefit of U.S. Provisional Application No. 62/748,714, filed Oct. 22, 2018.

This application claims the benefit of U.S. Provisional Application No. 63/049,723, filed Jul. 9, 2020.

The foregoing patent disclosure(s) is(are) incorporated herein by this reference thereto.

### BACKGROUND AND SUMMARY OF THE INVENTION

The invention generally relates to automated and/or mechanized food-process line equipment and, more particularly, to a contact drum freezer therefor as well as products produced thereby.

An example food product to run through a contact drum freezer could include for example and without limitation a meat patty. That is, something like a hamburger patty is relatively flattened between spaced broad sides, and the application of contact freezer service on one of the broad sides propagates freezing through the hamburger patty until solidly frozen through to the other broad side.

A shortcoming with prior art drum freezers is that the freezing service is so often only applied to one side of the food product. The freezing of the food product propagates from the side in contact with the drum to the other, far side.

It is an object of the invention to provide freeze-capable cooling service to the outside of the food product too (and not only the side of the food product in contact with the drum) so that there is a double-sided initiation and propagation of freezing through the food product.

It is another object of the invention to accomplish, through the passage of one machine, the lateral compression of a compressively-yielding food product (eg, whole peeled bananas or pieces thereof) as well bi-lateral service to the compressed food product of below-freezing temperatures.

As an aside, the temperature of ‘freezing temperature’ is a relative term in view of the specific food product. The reported freezing temperature for fresh water is thirty-two degrees Fahrenheit, zero degrees Celsius. And while bananas would no doubt require a lower temperature to freeze, for food product safety, it is desirable to go way below the minimum required temperature, to perhaps forty degrees below zero Fahrenheit (forty degrees below zero Celsius).

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a front perspective view of the infeed/outflow side of a contact drum freezer system in accordance with the invention for automated and/or mechanized food process lines, or more particularly, this FIG. 1 for the most part shows the two sections of the bifurcated housing (cabinets and hoods) therefor slid/moved SHUT (wherein the respective hood portions for each of the two housing sections are lowered CLOSED, on their respective cabinets, and the two housing sections are slid/moved laterally SHUT with respect to each other);

FIG. 2 is an enlarged-scale perspective view of the drum as well as the endless belt therefor, both in accordance with the invention, and shown fully in isolation of the housing sections and also shown about nearly in isolation from all the supporting sub-systems therefor;

FIG. 3 is an enlarged-scale perspective view taken in the direction of arrows in FIG. 1, in which the hoods are removed from view (as well as the near sidewall of the near cabinet) to better show the drum and endless belt as well as to better show portions of the supporting sub-systems therefor;

FIG. 4 is a section view taken along line IV-IV in FIG. 3;

FIG. 5 is a perspective view comparable to FIG. 1 except from a vantage point about 90° counterclockwise (about a quarter of way of circling around the machine to the right in FIG. 1), wherein the pair of housing sections are slid/moved laterally APART, the nearer section comprises the INSIDE treatment housing section and its hood is elevated OPENED, and the further section comprises the OUTSIDE treatment housing section and its hood remains lowered CLOSED;

FIG. 6 is an enlarged-scale perspective view of the OUTSIDE treatment housing section of FIG. 5 in isolation;

FIG. 7 is an enlarged-scale perspective view of detail VII-VII in FIG. 6;

FIG. 8 is an enlarged-scale perspective view of detail VIII-VIII in FIG. 9;

FIG. 9 is a section view taken along line IX-IX in FIG. 6;

FIG. 10 is a section view taken along line X-X in FIG. 1;

FIG. 11 is a section view taken along line XI-XI in FIG. 10;

FIG. 12 is a section view comparable to FIG. 11 except wherein the drum has rotated 45° clockwise;

FIG. 13 is an enlarged-scale perspective view of detail XIII-XIII in FIG. 10;

FIG. 14 is an enlarged-scale perspective view of detail XIV-XIV in FIG. 10;

FIG. 15 is a section view taken along line XV-XV in FIG. 14;

FIG. 16 is a perspective view comparable to FIG. 5 except not only with the housing sections removed from view but also from a vantage point about 180° counterclockwise (on the opposite side of the machine from FIG. 5) to show better how there is a service of an external chiller providing chilled refrigerant to the D'Limonene loops inside the machine and serving both the INSIDE treatment systems (with which the emphasis is on the drum) as well as the OUTSIDE treatment systems (with which the emphasis is on the air-knives directing freezing-temperature air onto the outside of the solid stainless endless wrapping belt);

FIGS. 17A-17C comprise a set of perspective views of an exemplary food product for freezing by the contact drum freezer system in accordance with the invention, wherein:

FIG. 17A is a perspective view of a fresh in-the-peel banana, with the peel being partly opened at the stem end;

FIG. 17B is a perspective view of a fresh, peeled banana with potential slice lines indicated in dashed lines providing suggestions, if it were desirable to reduce the whole banana down into pieces thereof, where such slices can be made; and

FIG. 17C is a perspective view showing that the exemplary food product for freezing by the contact drum freezer system in accordance with the invention might comprise any of:

a whole peeled banana,

halves of a peeled banana, or

sliced chips of a peeled banana;

FIG. 18 is a perspective view comparable to FIG. 2 showing the infeed and outflow of whole peeled bananas through the contact drum freezer system in accordance with the invention; and

FIG. 19 is an enlarged-scale perspective view of detail XIX-XIX in FIGS. 18.

### DETAILED DESCRIPTION OF THE PREFERRED EMBODIMENTS

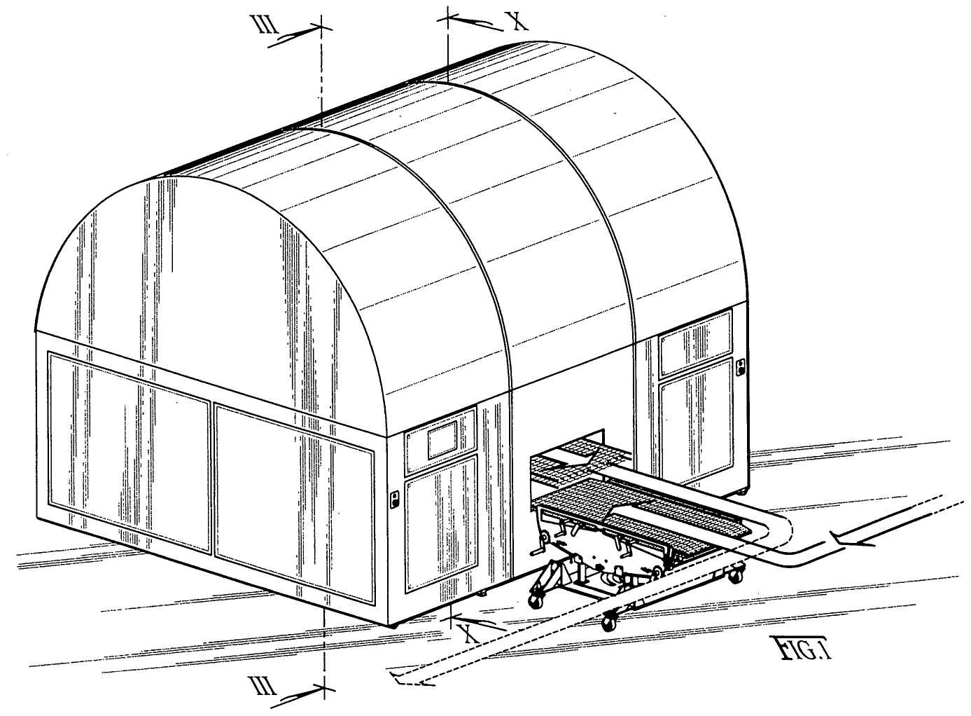

FIG. 1 shows the infeed/outflow side of a contact drum freezer system in accordance with the invention for automated and/or mechanized food process lines. More particularly, this FIG. 1 for the most part shows the two sections of the bifurcated housing (cabinets and hoods) therefor slid/moved SHUT. That is, the respective hood portions for each of the two housing sections are lowered CLOSED on their respective cabinets. And the two housing sections (cabinet and hood) are slid/moved laterally SHUT with respect to each other.

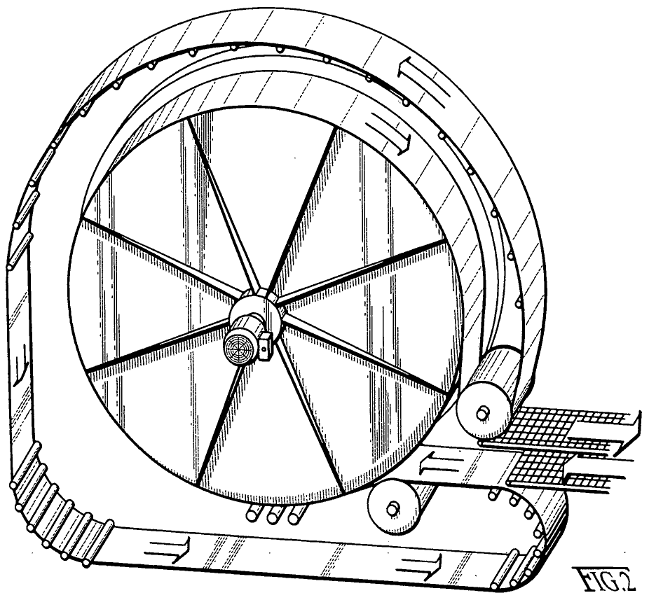

FIG. 2 shows the hard drum as well as the endless belt for wrapping around the drum fully in isolation of the housing sections, and also shown about nearly in isolation from all the supporting sub-systems therefor.

The contact drum freezer system in accordance with the invention would preferably be stationed to one side of a linear automated and/or mechanized food process line. Thus this the infeed/outflow side of the contact drum freezer system as shown in FIG. 1 is stationed to one side of the food process line, or the right-hand side of the food process line according to an observer standing upline and looking downline.

A system of direction-changing transfer conveyors would shift un-frozen food product off the linear transit path of the food process line (apart from the contact drum freezer system) onto the infeed portion of the endless belt for the contact drum freezer system. Other direction-changing transfer conveyors would shift the frozen food product outflowing from the contact drum freezer system back onto the linear transit path of the food process line. Thus in some short lineal length of about four feet or so, food product goes from being un-frozen to frozen by virtue of the side-stationed contact drum freezer system. Preceding stations or systems in the food process line might comprise any of loading, forming, dry-coating, seasoning, battering, par-frying and so on. Succeeding stations or systems in the food process line might comprise packaging and the like. The food process line as a whole might stretch out over one hundred feet or more.

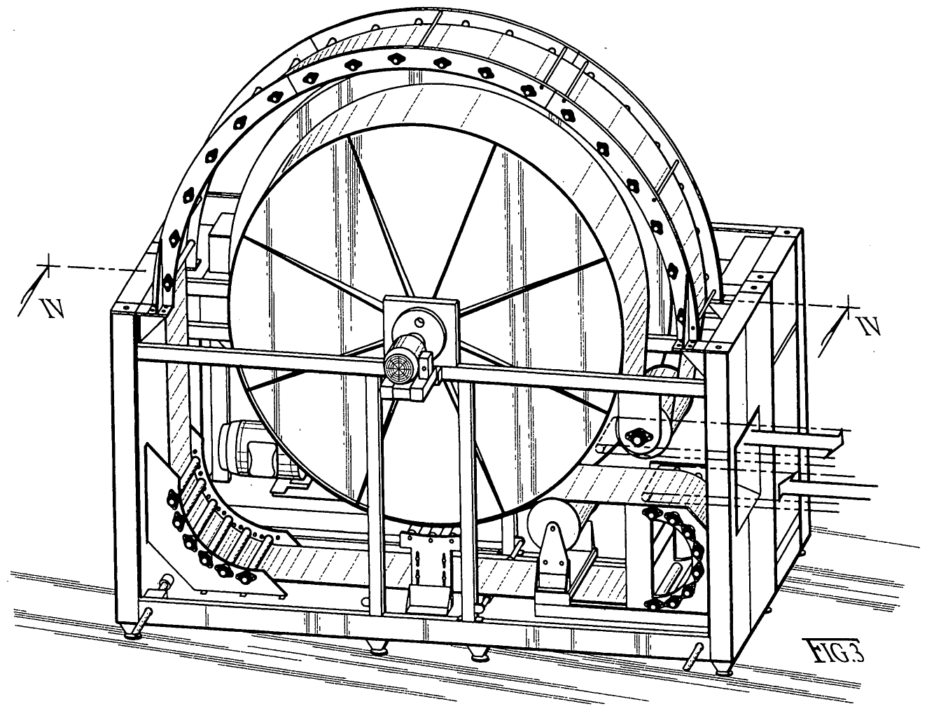

To return to FIG. 2, it shows the hard drum as well as the endless belt for wrapping around the drum nearly in full isolation. To look ahead to FIGS. 3-5, a contact drum freezer system in accordance with the invention for automated and/or mechanized food process lines comprises such a machine or component that includes without limitation the following major elements and/or support systems therefor:

1. a hollow drum and its support systems;

2. an endless belt which preferably comprises a continuous web of stainless steel sheet whereby the outflow of food product will not include texture markings of a textured belt;

3. an INSIDE treatment system of the machine (eg., coolant distributed to the inside surface of the hollow drum); and

4. An OUTSIDE treatment system of the machine (a series of curtains of chilled air aimed on the outside surface of the belt.

Arguably, when an observer observes the rotation of the drum, that scene might remind the observer of an old-fashioned water wheel (for example and without limitation, an overshot water wheel) of an old-fashioned 1800's grist mill. The drum is relatively large in diameter, relatively narrow in width, and turns slowly. However, the outer cylindrical surface of this drum comprises a continuously smooth hoop of stainless steel sheet (or of any other food grade approved material). An example diameter includes without limitation eight (8) feet, such choices on other diameters being a balance of choice to the scaling of the power consumption to factory ceiling height and so on. Example working widths include without limitation 14″, 24″, 40″ and 48″. Example rotation speeds include without limitation one rotation every two minutes (½ rpm).

The drum's outer cylindrical surface (eg., hoop sidewall) provides the inside freezing contact surface for food product. The outer cylindrical surface is chilled on the inside by impinging coolant fluid held at some selected setpoint (eg., minus forty degrees). The quantity (gpm), velocity (ft/min), drop size, and flow pulsation of the impinging coolant are all variables in providing the outer cylindrical surface with the capability of very high amounts of heat exchange (eg., energy extraction from the food product). As the coolant fluid is thrown at the outer cylindrical surface, it is an object of the invention that the coolant fluid actually hit the outer cylindrical surface, and this depends in part on the location of the impingement, and controlling impeding factors such as the diversion and removal of already landed fluid and the prevention of thick layers of fluid. Such impeding factors could impede and dampen the ability of the outer cylindrical surface to get all the way down to the setpoint temperature. These impeding factors are minimized by side flow diverters around the inside of the drum to guide a return flow of coolant fluid to a drain ring and away from the heat transfer surface (ie., the outer cylindrical surface).

FIG. 3 has the hoods are removed from view (as well as the near sidewall of the near cabinet, which houses the an INSIDE treatment system) to better show the drum and endless belt as well as to better show portions of the supporting sub-systems therefor.

Any or all of FIGS. 1-4 provide indications/illustration of food product path, solid stainless steel belt, product exit (or outflow), product infeed, product Separation (and ultimate ejection) from both the drum and belt, a belt tensioning system, a product pre-squeeze or compression system, and a cooperating product thickness control system.

FIGURE provides a view of the first roller or set of rollers that incoming food product transits over, and over which the belt would roll. This roller or set of rollers might be referred to as a ‘prep’ or ‘clearance’ roller(s).’ This(these) prep roller(s) is(are) preferably mounted on a ‘sled’ that is biased to provide constant-force tension on the belt.

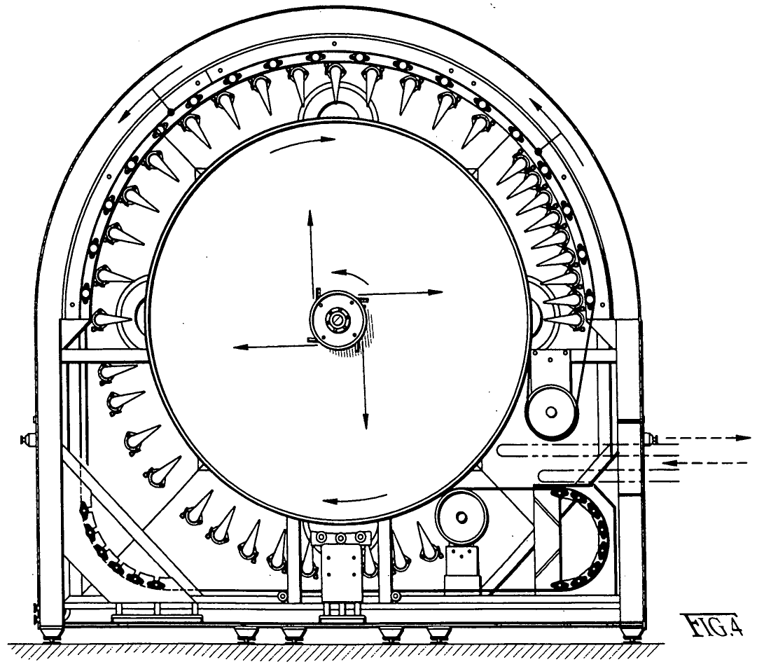

FIG. 4 also shows a series of three (3) ‘gauge’ rollers (product pre-squeeze or compression system) which gird an arc at the bottom of the drum and compress the food product to the desired thickness (ie., in cooperation with the product thickness control system). Thus the desired objective is that the food product preferably comprises a stream of food product pieces (eg., hamburger patties) that are uniformly flat and share a uniform thickness.

FIG. 4 also shows aspects of the coolant slinging system with the interior of the drum, and a plenum configuration that surrounds the drum and belt with well below-freezing chilled air. Again the solid belt presses food product such that there is good thermal contact that the food product makes with both the outer cylindrical surface of the drum the inner cylindrical surface of the belt.

Fans are employed to force the well below-freezing chilled air through narrow elongated slit-like nozzles aimed at the outer cylindrical surface of the belt. That way, the food product receives bilateral freezing service from the contact with the drum on the inside surface of the food product and the belt on the outside surface of the food product.

Again, FIGS. 2-4 generally allow discernment of a pre-thickness roller that first initially compresses food product and then thickness gauge rollers employed to reach a selected thickness for the food product.

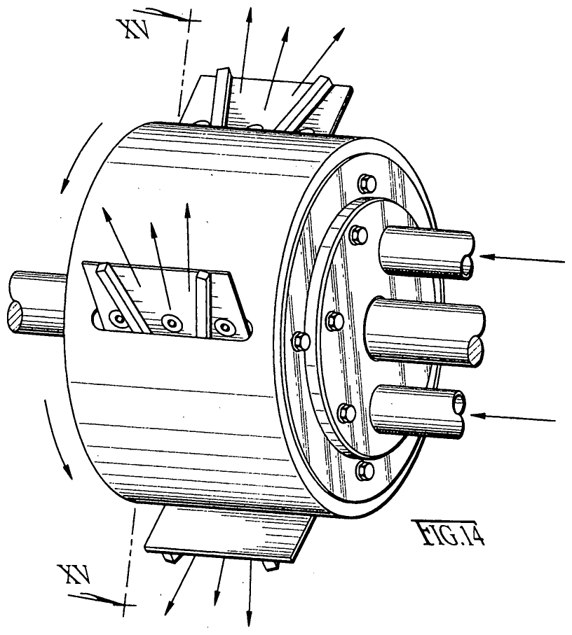

FIG. 4 shows basic aspects of the coolant slinger system that will be described more particularly below in connection with FIG. 14, as well as basic aspects of food product separation from the drum and belt as well as ultimate discharge.

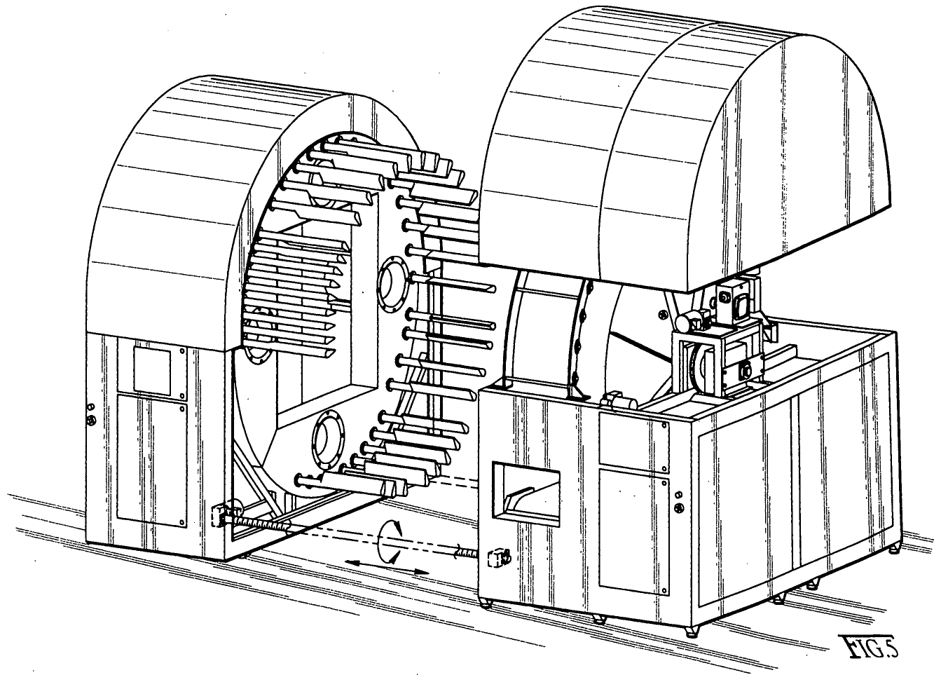

FIG. 5 shows the pair of housing sections slid/moved laterally APART. The nearer section comprises the INSIDE treatment housing section and its hood is elevated OPENED. The further section comprises the OUTSIDE treatment housing section and its hood remains lowered CLOSED.

It is an aspect of the invention that the housing sections are slidable/movable to a spread APART state as for cleaning (and maintenance and so on).

Again, in FIG. 5, the right half of the machine (housing section) comprises the drum and the coolant reservoir and is referred to as the INSIDE treatment system of the machine. The left half comprises an annular ring of air knives and is referred to as the OUTSIDE treatment system of the machine.

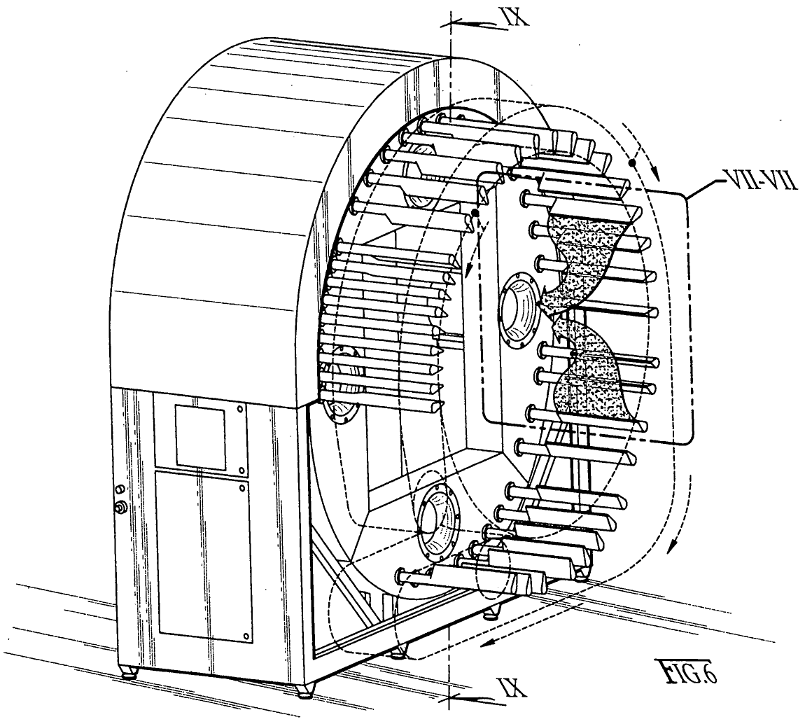

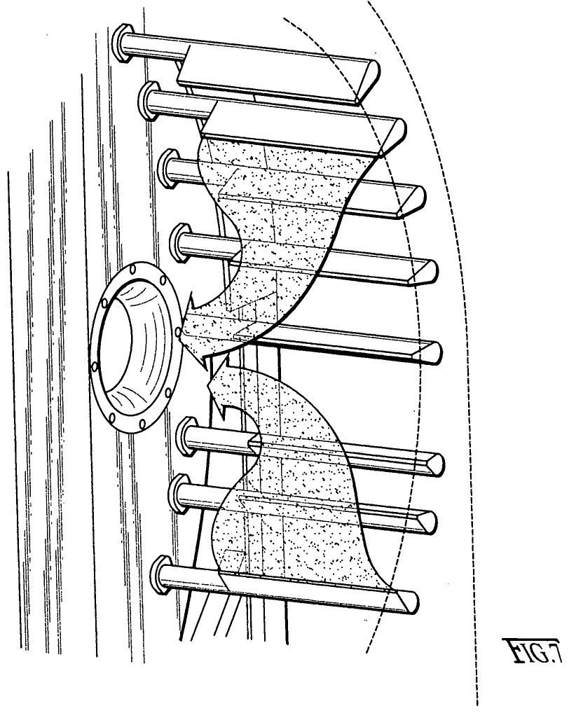

FIGS. 6 and 7 better show aspects of the OUTSIDE treatment system for the machine. As mentioned above, the OUTSIDE treatment system comprises an annular ring of air knives blasting well-below freezing chilled air directly at close range onto the outside of the belt.

FIG. 7 shows better on an enlarged scale of one (1) bank of the four (4) banks of air knives. Preferably each bank comprises an equal number of air knives to balance the pressurization thereamong (and presumably outflow therefrom). An example number of air knives per bank including without limitation nine (9) or so.

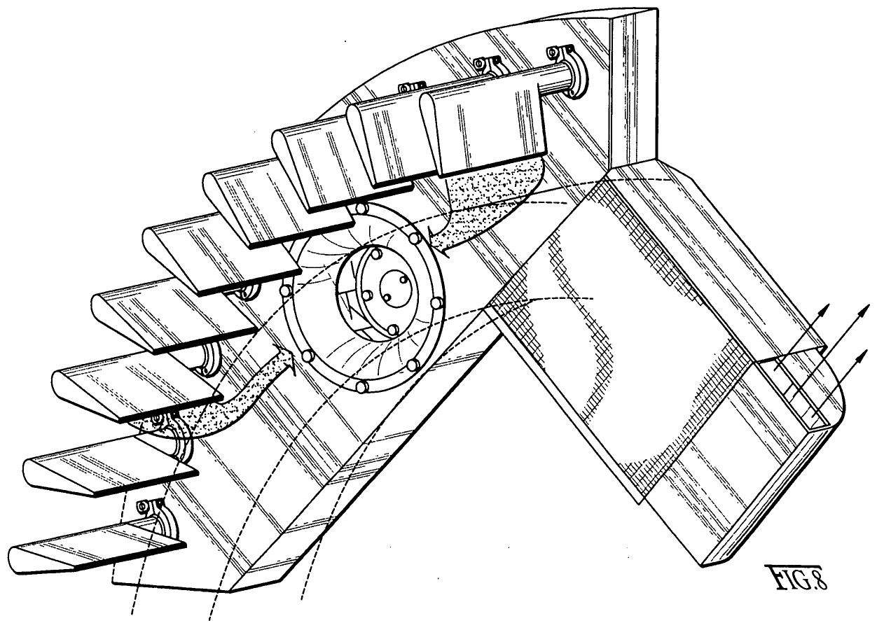

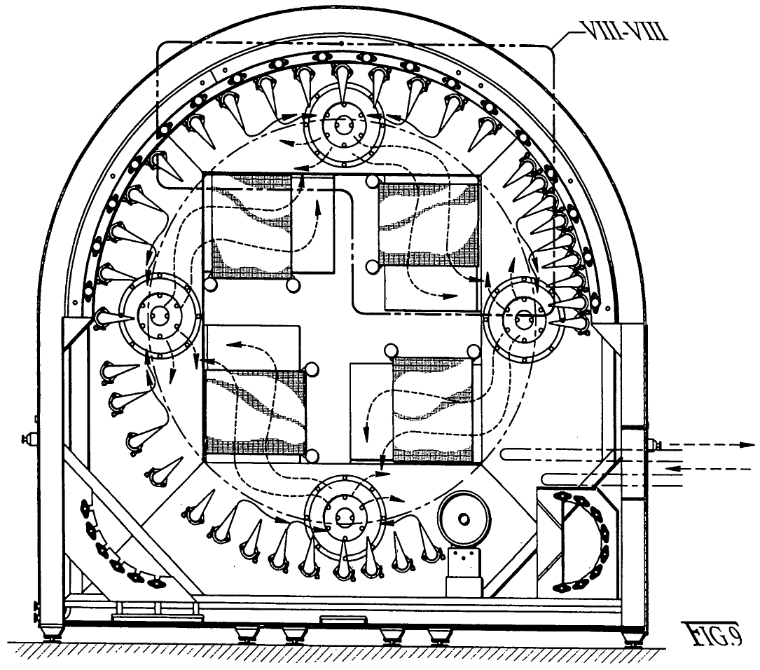

FIG. 8 is an enlarged-scale perspective view of detail in FIG. 9. Alternatively, FIG. 8 is a radially-outboard perspective view of several of the air knives from a vantage point close to the central turning axis of the drum (the drum is not in view. FIG. 8 shows one of the four (4) identical banks comprising an air plenum, an air cooler, a blower and a plurality of air knives. Wherein the air loop is a closed system and circulates serially from one bank to the next and so on, progressively circulating in a loop around the four (4) banks and impinging on the outside of the belt. As mentioned previously, the belt preferably comprises a continuous web of solid stainless steel sheet. Not only will the outflow of food product will not include texture markings of a textured belt, but the energy extraction of above-freezing temperature out of the food product will be increased.

Again, FIG. 8 shows aspects of the air plenum configuration, the roto-freeze technology, the air nozzles, the chilled air to next plenum, the air plenum, the air chiller and a fan inlet.

FIG. 9 is a section view taken along line IX-IX in FIG. 6. Alternatively FIG. 9 is a left side elevational view of the OUTSIDE treatment system of the machine in the foreground and portions of the drum in the background indicated by dash line. Here, the four (4) separate combination air chillers/air plenums of the OUTSIDE treatment system of the machine are removed from view.

Thus, FIG. 9 shows aspects of the plenum configuration, the drum/belt side showing air loops, a fan inlet (typical), an air loop both for nozzles & chiller (typical), a typical air loop:

plenum to air nozzles,

to belt,

to fan inlet, and

Chiller from Plenum to next fan inlet:
Chiller—P4-P1,
Chiller—P1-P2,
Chiller—P2-P3,
Chiller—P3-P4.

Regardless if redundant with the foregoing, FIG. 9 shows aspects of the plenum configuration for applicant's roto-freeze technology, Plenum number 2, access doors, Plenum number 1, air path (from P4 to P1), Plenum number 4, Plenum number 3 and air chillers.

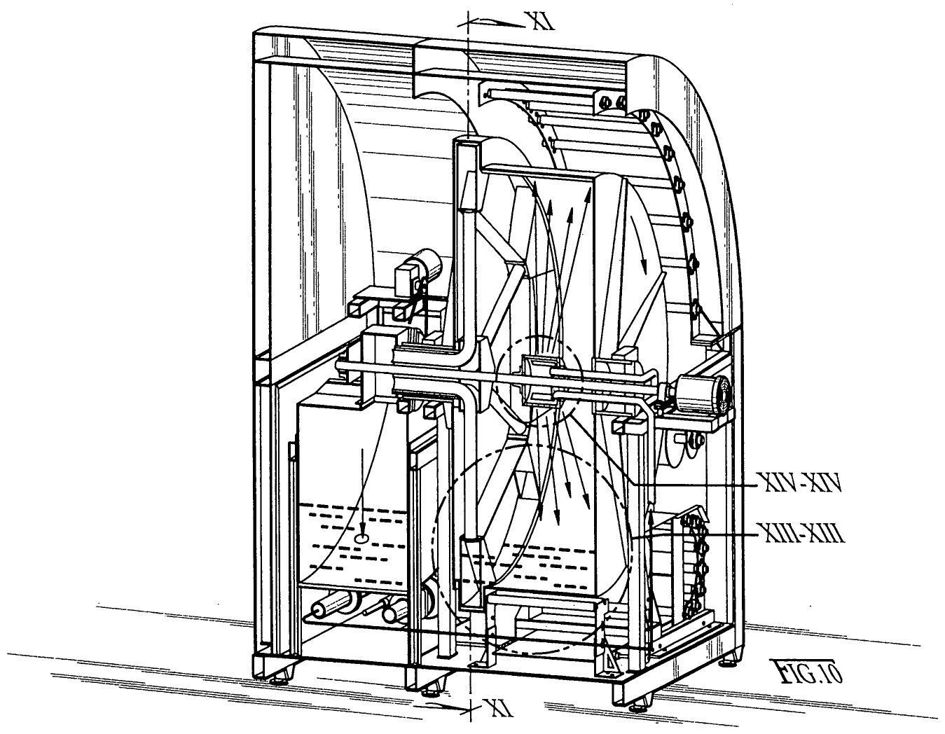

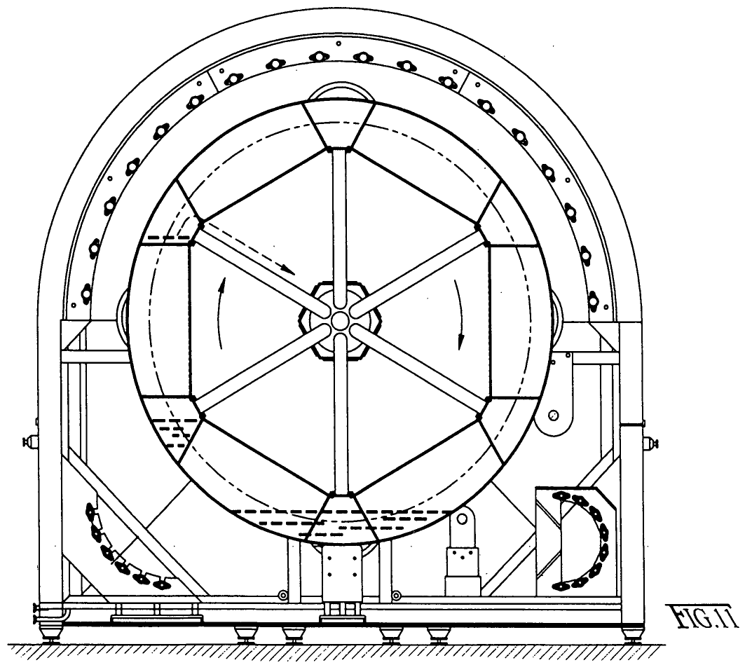

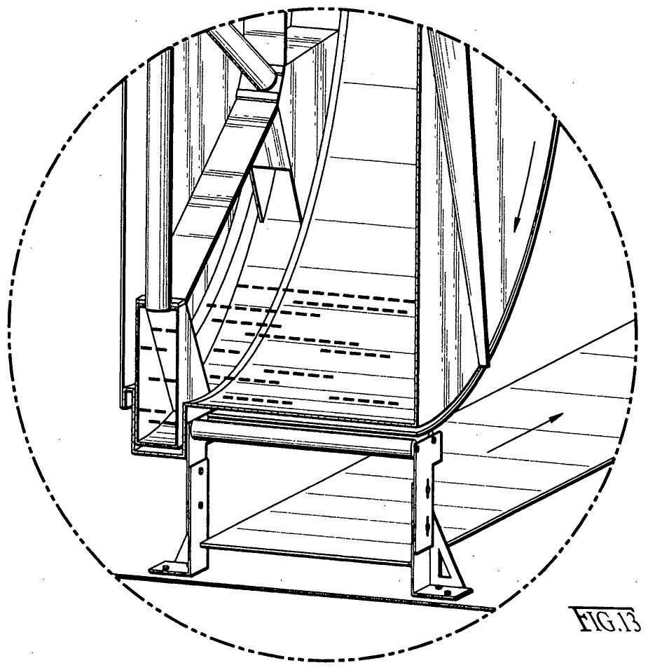

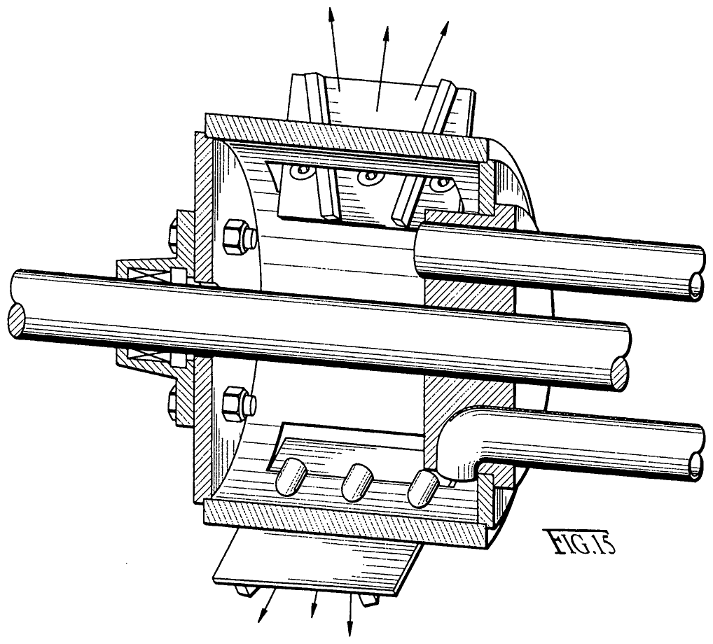

FIG. 10 is a section view taken along line X-X in FIG. 1, showing the internal coolant slinger as well as the coolant flow paths for this much of the machine (eg., the INSIDE treatment system of the machine). FIG. 10 as well as FIGS. 11-15 show better the return of the coolant by the water-wheel provision(s) of the drum.

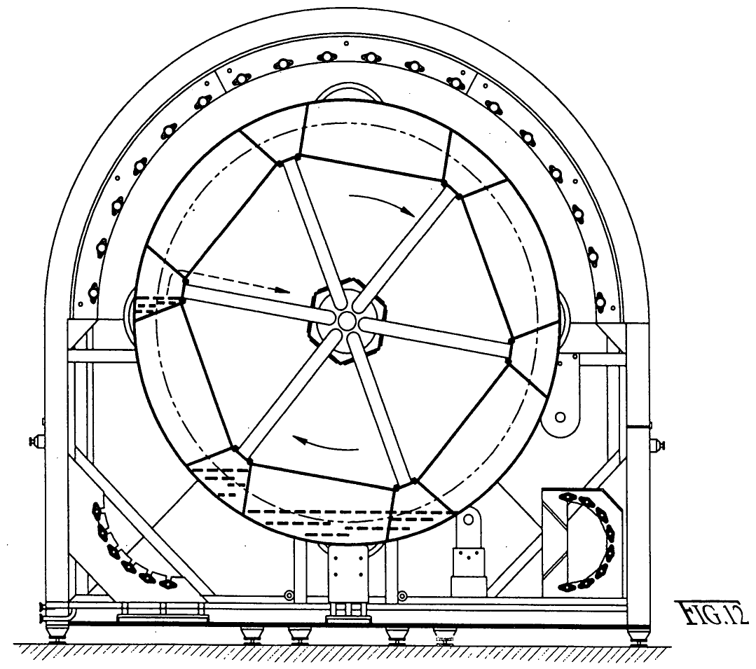

Note that FIG. 12 is a section view comparable to FIG. 11 except wherein the drum has rotated 45° clockwise.

FIGS. 10-15 show aspects of the liquid loop servicing the drum, applicant's roto-freeze technology, the drum, the slinger, the coolant fluid inflow into drum slinger for distribution inside drum, the water wheel hub, the water wheel scoop/bucket, the liquid drainage from scoop, the return to the storage tank, the drain ring, and the pump to slinger.

Regardless if redundant with the foregoing, FIGS. 10-15 shows the coolant liquid path for applicant's roto freeze technology, including:

1. Storage tank,

2. Piping to slinger,

3. Slinger,

4. Impact inside drum,

5. Drainage-evacuation water wheel, and

6. Flow back to tank.

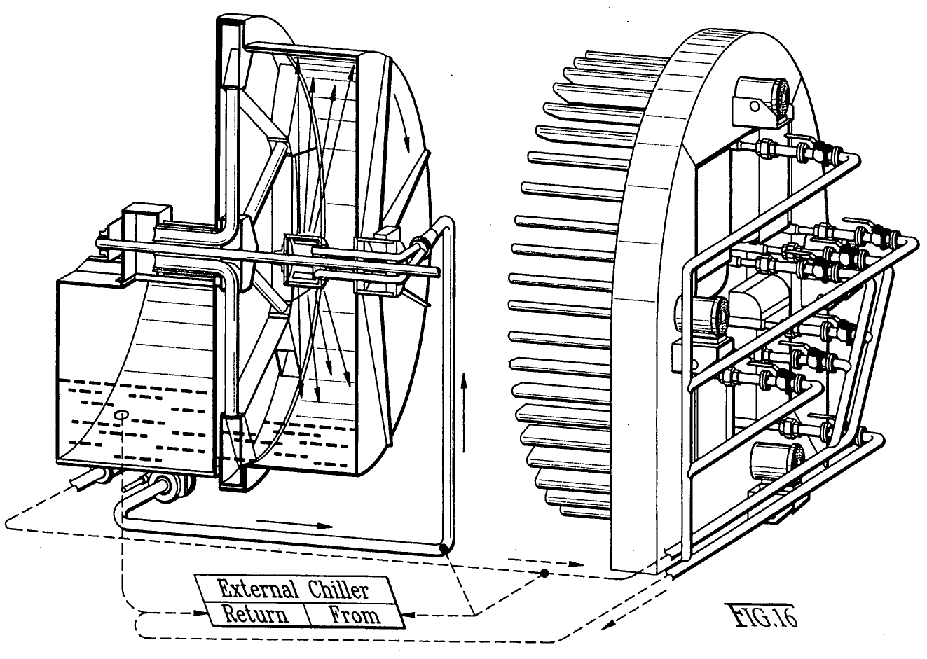

FIG. 16 is a perspective view comparable to FIG. 5 except not only with the housing sections removed from view but also from a vantage point about 180° counterclockwise (on the opposite side of the machine from FIG. 5) to show better how there is a service of an external chiller providing chilled refrigerant to the D'Limonene loops inside the machine and serving both the INSIDE treatment system (with which the emphasis is on the drum) as well as the OUTSIDE treatment system (with which the emphasis is on the air-knives directing well-below freezing temperature air onto the outside of the solid stainless endless wrapping belt).

FIG. 16 shows better that when the respective housing sections are spread APART, the OUTSIDE treatment system neatly separates from the INSIDE treatment system. Wherein, the belt travels with the INSIDE treatment system, but one of the main objects of the OUTSIDE treatment system is to chill the belt to down below well-below freezing temperatures by means of a nearly continuous annularly-ward close range blast of such cold air. Hence the annular ring of the air knife nozzles separate neatly apart from the outer cylindrical surface of the belt.

FIG. 16 shows aspects of not only the D'Limonene liquid coolant loop for not only the OUTSIDE treatment system but also the INSIDE treatment system, including the air chillers, applicant's roto-freeze technology, the coolant fluid storage tank, the flow back to storage tank, one or more air chillers, and the coolant fluid into air chiller.

As an aside, the external chiller might be a heat exchanger in which the external working fluid is ammonia. The ammonia lines and heat exchanger are not wanted within indoor premises. Hence the external chiller and the ammonia-flowing refrigeration equipment and lines are all preferably located remotely away and outdoors. The safer-to-handle D'Limonene.

The following comprises a summary of operation given the foregoing matters above. Coolant fluid flows in/out of the drum by a centrifugal pump that sends the fluid over to the slinger (gpm or quantity) which delivers fluid slung about 360 degrees inside the drum. Piping brings the flow into the inside of the slinger and it is carried out by centrifugal force onto multiple blades fitted with fanning fins to spread the flow to the width of the drum. The number of blades also, along with the spinning speed of the slinger, creates the pulsation of the flow onto the surface. The tip speed of the blades determines the velocity of the flow into the surface.

Containment of the coolant fluid. Fluid is transported from the tank to the drum by piping through both inlet and outlet spindles of the drum. These also serve for the rotation of the drum on bearings.

Drum Skin Metal. The heat transfer surface of the drum is typically thin wall stainless steel (16 ga. or 0.0625″). Copper can also can be used (16 ga.). The thermoconductivity of copper is 25 times higher than stainless steel. Copper also has anti-microbial properties that could be advantageous.

Distribution of fluid (coolant) to the drum skin (eg., cylindrical outer wall). This preferably comprises a paddle slinger. The current slinger has 4 paddles fitted with spreading fins which fan the flow out to the width of the drum. The paddles also provide for separation of flow (pulsation), which creates a “pounding” of the fluid into the surface. It also gives the fluid time to flow away from the surface before the next wave comes in, thus improving the “in and out” flow of fluid on the surface.

There is alternatively a drum slinger. The preference of characteristics with a drum slinger vary with hole densities and sizes. Thickness of the wall thickness also provides for straightening of the flow from each hole, which improves fluid coverage into the surface, and overall heat transfer. The variance in nozzle (hole) definition (thickness) is from the thinnest at 16 ga. (0.0625″) up to 1″ thick plastic (PVC). The thicker nozzle gives better exit stream definition.

Spray Nozzles could also be used. Typical water spray nozzles were arranged in a header (up to 10 across at spacing of 1.5″ apart) feeding a drum width of 16 inches. The multiple headers were positioned 12″ apart.

With a fluid fill in drum, no distribution method is utilized. Static storage of the coolant fluid inside the drum providing contact with the surface keeping it at the temperature of the coolant fluid. Note this can be “still” fluid, or agitated or moving using either paddles or internal nozzles.

The evacuation and recirculation of the fluid can be achieved by alternative means. For example, drain tanks. The circumference of the drum is divided into 8 sections, each draining into an discrete adjacent tank, as it rotates, thus clearing the drum of added fluid. It the treatment time is X seconds, but it takes more gallons than the drainage capacity of the tanks, fluid can build up inside the drum.

Or there could be a drain ring with a water wheel. If there is a continuous drain ring around the drum (to the side), and the fluid is allowed to enter this drain, then a wheel containing scoops to remove the fluid can keep the ring clear of accumulated fluid. This will allow the drum to turn at very slow speeds, but the water wheel running high enough speeds to keep all fluid removed from the drain.

The water wheel is a rotating array of scoops or cups which fill up and drain fluid out of the area. The speed is set according to the evacuation requirements of the fluid.

A pump with suction method utilizes a suction line located down in the drain ring, which pulls the fluid out of the drum.

The preferred coolant fluid includes without limitation D'Limonene. It is cooled by external coolants which have even lower working temperatures (eg., ammonia).

The OUTSIDE treatment system of the machine refers to the cooling of air for the impingement on the outside of the belt. The air should be cooled down to a setpoint of about −40° F. (−40° C.) or so. There would be air-handling plenums and coolers. The coolers preferably have a zig-zag flow of panels. These are-mounted outside the plenum and are pressured from air from the plenum and returning back into the inlet of the blower.

Food product handling is generally handled the following way. Product is brought into the unit on a wrapping belt. This mates with the drum to form both inside and outside surfaces. This, being a solid metal belt, is non-porous (impervious) and will not allow any moisture migration from the surface of the product, thus providing no escape point for yield loss. This also provides a smooth surface on both surfaces of the product. A gauging (set of) roller(s) puts pressure on the thickness of the product as it comes in contact with the product. The belt tension maintains that thickness, thus allowing, when freezing, production of a thinner product, which has strong advantages for food service needs and process (freeze or cook) time, both in control and reduction. The consistency of the thickness also allows for more predictable preparation times, which has great advantages to their operation.

The food product freezes or is chilled by both contact with the drum surface and the belt surface. By holding the product between two solid surfaces, pressure can be increased (increasing heat transfer) and processing thinner shapes can reduce the heat transfer time through the product, while also improving the consistency of the temperature.

This machine could be serviced with a thermal fluid other than a coolant fluid, and thus, instead of being a contact drum freezer system, the machine would become a contact drum cooker system. Although this departs from the main design focus of freeze service.

But freezing has been the inspiration of the developments to date. The direct contact with a high heat transfer surface reduces the ice crystal size and growth, thus producing a superior product. The smooth surface is an advantage. Impervious surface is believed to maximizes processing yield and maintain product quality.

The machine could be. devised for thawing. This would be similar as freezing, threshold temperatures can be much more accurate thus maintaining product quality and maximizing process throughput, while avoiding “over cooked” extremities.

To re-devise for cooking, cooking can be maximized with highly accurate surface temperatures maintained. Moisture migration away from the surface is eliminated because of the solid surface.

Branding could be achieved too. It would be a much improved process due to higher controlled temperatures and conduction heat transfer. Heating grids can be placed just under the surface for direct heat transfer into regions of the product, for example, pressing with a solid belt. The dual solid surfaces-maximizes heat transfer and minimizes moisture and fluid loss, and produce a higher appealing profile, and which can be used to shape the product where otherwise not possible. This also could allow “cooking in gravy,” or also allow pouch processing, where product is pre-packaged and then processed (cook in the bag) for enhanced safety processing. This could change the packaging of food items from being in a can to in pouches. There is also the ability for pressing with a mesh belt and holding strips (breaded product, non geometrical). This would allow the top treatment-air impingement, smoking, infrared, other to surround the product without flattening it. And then there is also pressing for preshaping flatness and other shapes. This could allow for “formed” product process, either cooking or freezing, for shaping during processing.

To return the OUTSIDE treatment system of the machine, this is essentially an air impingement system (hot or cold), or steam impingement, of infrared, or smoke onto a solid belt or onto the product through a mesh belt. That way, there could be direct smoke impingement, directly onto the product through the open interstices of the belt.

The overall configuration can be summarized briefly as follows. There are supply plenums, air nozzles like single slot nozzles, eg., air knives that have a single slot and produce a single curtain of air. There could be cross flow nozzles, developed in housing, causing a cross flow of air at exit for more chaotic air exchange with the surface and higher heat transfer. There could also be bell nozzles (hybrids), which convert a straight nozzle to more chaotic flow for better heat transfer. There could also be tube nozzles, which are tubes for delivery of an air column to the surface.

In contrast to direct impingement, there could also be indirect impingement. This would involve a solid belt with impingement nozzles directed at the belt and using the belt as the heat transfer surface. There might be a belt with heated rollers that transfer heat into the belt instead of nozzles. There might be thermal mass blocks with or without a belt, but preferably with a belt, Where the blocks contain enough mass to contain the heat for transfer to the belt and then to the product. Or that the blocks might have a flat surface and act directly on the product with no belt.

The housing for the machine comprises a pair of cabinets and a pair of hoods. The hoods lift up (perhaps off) for cleaning. The cabinets spread APART somewhat like a clam shell, again for access to the internal parts, maintenance, cleaning and so on.

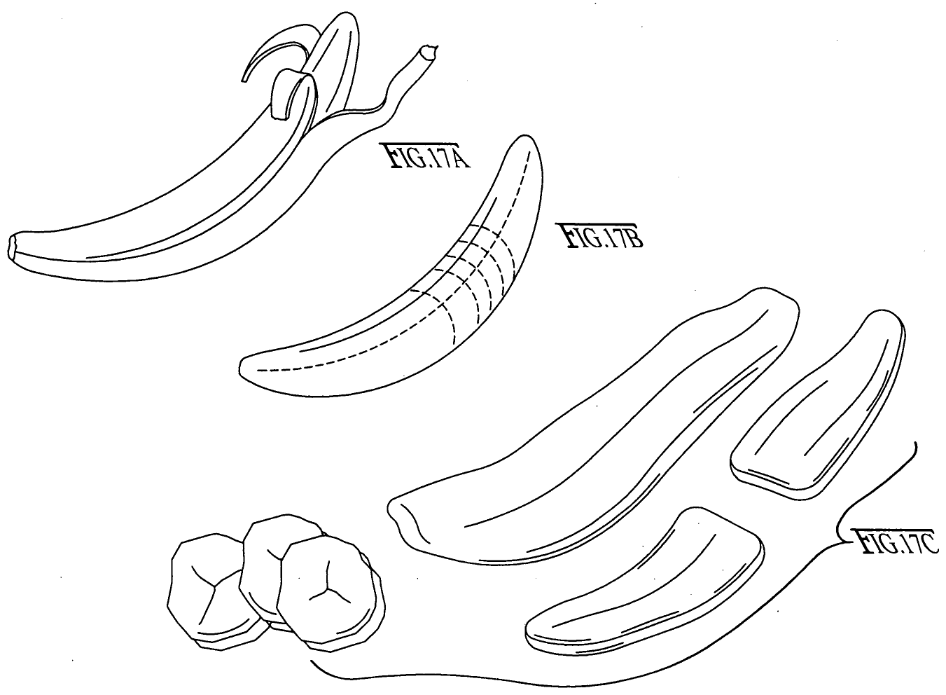

FIGS. 17A-17C comprise a set of perspective views of an exemplary food product for freezing by the contact drum freezer system in accordance with the invention, wherein:

FIG. 17A is a perspective view of a fresh in-the-peel banana, with the peel being partly opened at the stem end;

FIG. 17B is a perspective view of a fresh, peeled banana with potential slice lines indicated in dashed lines providing suggestions, if it were desirable to reduce the whole banana down into pieces thereof, where such slices can be made; and

FIG. 17C is a shows the exemplary food product being fed into the machine for freezing by the contact drum freezer system in accordance with the invention, which food product might comprise any of:

a whole peeled banana,

halves of a peeled banana, or

sliced chips of a peeled banana.

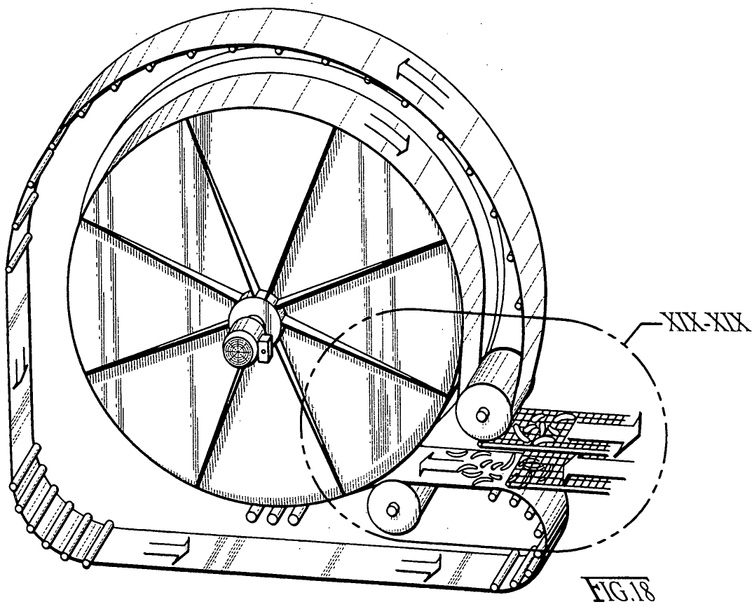

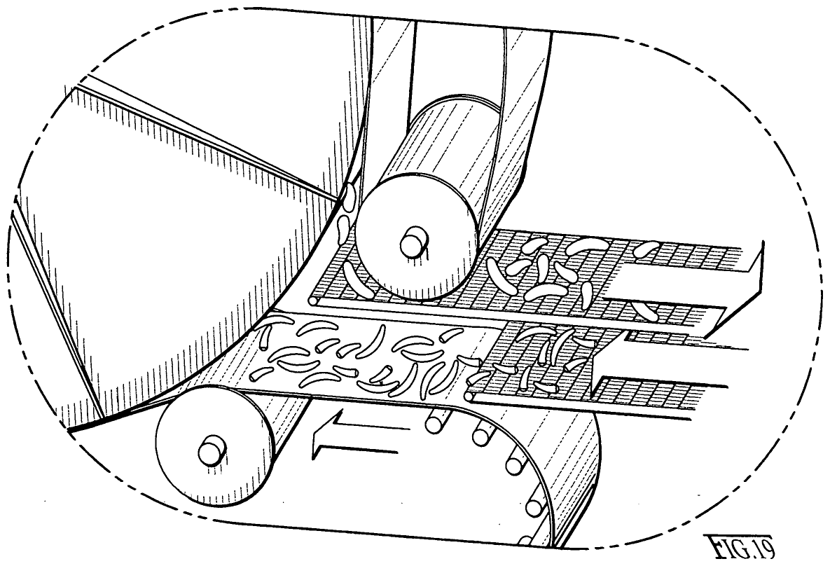

FIGS. 18 and 19 show the infeed and outflow of whole peeled bananas through the contact drum freezer system in accordance with the invention. The contact drum-freezer system comprises a revolving drum and a counterpart, endless, product wrap belt which has an outer return run and an inner product-compressing run. This inner product-compressing run provides the inner cylindrical surface portion of the belt that provides the direct contact with the food product on the outside. The outer surface of the drum skin provides the direct contact with the food product on the inside. The revolving drum's outer surface and belt travel at the same speed.

Fresh, whole peeled bananas are fed into an infeed opening in the machine on an infeed conveyor. The fresh, whole peeled bananas are admitted for a ride comprising one circuit on the revolving drum's outer surface. At the termination of such a ride, the food product (ie., banana here) is:

laterally compressed,

frozen, and

ultimately discharged out of the machine.

The contact drum-freezer system comprises biased belt-tensioning devices for the product wrap belt such that bananas riding a circuit between the drum's outer surface and the product wrap belt's product compressing run are not only conveyed thereby, but concurrently laterally compressed thereby.

The contact drum freezer system also comprises a source of refrigeration for bringing the temperature of the drum's outer surface to well-below freezing (eg., −40°). Thus bananas riding a circuit between the drum's outer surface and the product wrap belt's product-compressing run are frozen by contact with the drum's outer surface's well-below freezing temperature and the product-compressing run's inner surface's well-below freezing temperature.

The product wrap belt is held under a moderate tension, thus applying moderate pressure to the food product and thereby moderately forcing the food product between the freezing drum and the freezing belt. Such pressure increases the heat transfer rate of the freezing. The application of pressure on the product between the drum and belt is achieved not only by the biased-tensioning devices for the product wrap belt but also by assistance from compression rollers or compression belts mounted along the arc or arc segments of the product wrap belt. As food product rides a circuit on the drum's surface and freezes, the product approaches one or more scraper blades, which scrape or separate the frozen product off and away from the drum and belt.

Experience finds that a minuscule interface or layer of ice crystals forms between the drum and inside surface of the food product as well as the belt and outside surface of the food product. Since the freezing rates at the product-drum and/or product/belt interface are very fast, the ice crystals are very small. This allows food product to be easily scraped off the respective drum and belt surfaces. By these means, both the food product's inner side (ie., the drum-contact side) and outer side (ie., the belt-contact side) are very smooth. Preferably the overall shape of individual pieces of food product is very flat, which serves well for closely-spaced packing in cases or cartons. Likewise, the food product's outer side (eg., the belt-contact side) is flat as well due to the product wrap belt being a continuous film. A preferred material for the product wrap belt is solid stainless steel sheet. “Solid” here means, absence of open interstices such as perforations or chain link and otherwise.

Once the food product reaches the scraper blades and is pried away from the surfaces of the drum and belt, the product falls onto an outflow conveyor. The outflow conveyor transfers the frozen product onwards, to downline processes that are not shown, perhaps by means of intermediary transfer conveyors that change the path of the outflowing food product to right angles of the outflow conveyor. Such downline processes could include without limitation packaging or scaling areas where product is apportioned, bagged, sealed, boxed and stacked on pallets for shipping or the like.

It is an advantage of the invention that product can be frozen over a brief time span during which a flat shape is maintained, with both broad sides of the food product being maintained very smooth. The food product is subjected to freezing process simultaneously with being mechanically compressed in a progressively thinning gap between converging broad flat surfaces of the drum and belt, and not by vacuum compression, screw compacted, extrusion or other.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. A contact drum freezer system comprising:
a contact drum freezer mounted to revolve about an axis generally parallel to a main lane of transit;
an endless product wrap belt having an intake shelf, an inner product-compressing run encircling most of the drum and an outer return run looping back to the intake shelf; and
a cross feed conveyor situated in the main lane of transit having a return run and product-carrying run for transferring product laterally out of the main lane of transit and onto the intake shelf of the product wrap belt;
wherein said contact drum freezer comprises a hollow drum and support systems therefor;
said contact drum freezer system further comprises an INSIDE treatment system for the hollow drum; and
said contact drum freezer system further comprises an OUTSIDE treatment system for the endless product wrap belt.

2. The contact drum freezer system of claim 1, wherein:
the OUTSIDE treatment system for the endless product wrap belt comprises a series of curtains of chilled air aimed on the outside surface of the endless product wrap belt.

3. The contact drum freezer system of claim 2, wherein:
the endless product wrap belt preferably comprises a continuous web of stainless steel sheet whereby the belt is food grade and a good thermal conductor, as well whereby the outflow of food product will not include texture markings of a textured belt.

4. The contact drum freezer system of claim 3, wherein:
the INSIDE treatment system for the hollow drum comprises a fluid coolant distributed to the inside surface of the hollow drum.

5. The contact drum freezer system of claim 4, wherein:
the coolant comprises D'Limonene.

6. The contact drum freezer system of claim 1, further comprising:
a housing for the contact drum freezer system;
wherein the housing comprises a cabinet and hood;
wherein the hood lifts off for cleaning; and
the cabinet comprises a first and second opposed clam shell-inspired structures that spread apart from one another whereby providing access to internal parts and for maintenance and cleaning.

7. The contact drum freezer system of claim 6, wherein:
the OUTSIDE treatment system for the endless product wrap belt is supported by the first clam shell-inspired structure, and travels with the first clam shell-inspired structure when the first clam shell-inspired structure is spread apart from the second clam shell-inspired structure.

8. The contact drum freezer system of claim 7, wherein:
the INSIDE treatment system for the hollow drum is supported by the second clam shell-inspired structure, and travels with the second clam shell-inspired structure when the second clam shell-inspired structure is spread apart from the first clam shell-inspired structure.

9. The contact drum freezer system of claim 8, wherein:
the OUTSIDE treatment system for the endless product wrap belt comprises a series of curtains of chilled air aimed on the outside surface of the endless product wrap belt.

10. The contact drum freezer system of claim 9, wherein:
the endless product wrap belt preferably comprises a continuous web of stainless steel sheet whereby the belt is food grade and a good thermal conductor, as well whereby the outflow of food product will not include texture markings of a textured belt.

11. The contact drum freezer system of claim 10, wherein:
the INSIDE treatment system for the hollow drum comprises a fluid coolant distributed to the inside surface of the hollow drum.

12. The contact drum freezer system of claim 11, wherein:
the coolant comprises D'Limonene.
